(19) United States
(12) Patent Application Publication
(10) Pub. No.: US 2019/0211423 A1
(43) Pub. Date: Jul. 11, 2019

(54) ALUMINUM ALLOY HARD THIN FOIL FOR SECONDARY BATTERY CATHODE COLLECTOR, SECONDARY BATTERY CATHODE COLLECTOR, AND METHOD FOR MANUFACTURING ALUMINUM ALLOY HARD THIN FOIL

(71) Applicant: MITSUBISHI ALUMINUM CO., LTD., Minato-ku, Tokyo (JP)

(72) Inventor: Hiroaki NISHIDA, Shizuoka (JP)

(73) Assignee: MITSUBISHI ALUMINUM CO., LTD., Minato-ku, Tokyo (JP)

(21) Appl. No.: 16/326,847

(22) PCT Filed: Aug. 15, 2017
(86) PCT No.: PCT/JP2017/029358

§ 371 Date: Feb. 20, 2019

(30) Foreign Application Priority Data
Aug. 29, 2016 (JP) 2016-166922

(51) Int. Cl. C22C 21/00; H01M 4/66; C22F 1/04

(52) U.S. Cl. CPC C22C 21/00; H01M 2004/028; C22F 1/04; H01M 4/662

(57) ABSTRACT

A foil is manufactured as an aluminum alloy hard thin foil, wherein the aluminum alloy hard thin foil has an alloy composition wherein a content of Fe is 0.05 to 2.0% by mass, with the balance being aluminum and inevitable impurities; a recrystallization completion temperature is 250° C. or less; and a foil thickness of 5 to 50 μm. The aluminum alloy hard thin foil can be obtained by subjecting an aluminum alloy having, for example, a composition wherein a total content of Cu, Mg, Cr and Zr is 0.05% by mass or less, and a content of Mn is 0.05% by mass or less to intermediate annealing once or more during cold rolling and subjecting the resulting alloy to cold rolling wherein a reduction ratio from after final intermediate annealing to after final cold rolling is 85% or more.

### TECHNICAL FIELD

This invention relates to an aluminum alloy hard thin foil which can be suitably used for secondary battery collectors, a secondary battery cathode collector using the aluminum alloy hard thin foil, and a method for manufacturing the aluminum alloy hard thin foil.

### BACKGROUND ART

Secondary batteries such as lithium ion secondary batteries are used as power supplies for mobile electronic equipment such as mobile phones and notebook computers in recent years. The adoption of lithium ion secondary batteries into the car-mounted batteries of ecological cars such as hybrid and electric cars has also been expanded.

Aluminum foils are used for collectors of lithium ion secondary batteries and the like. An active material having a size of around 1 μm is applied to both sides of aluminum thin foils having a thickness of around 15 to 30 μm together with a solvent, the aluminum thin foils are dried to remove the applied solvent and further subjected to a crimp step to increase the density of the active material to manufacture cathode plates.

The thinning of the aluminum foils, which are electrode collectors, is required to increase the capacity of lithium ion secondary batteries. Since the aluminum foils used as the collectors of cathodes are thinned, and they are easily ruptured in battery production lines. Therefore, when the aluminum foils are processed, the foils are processed in a hard state to suppress rupture. Then, although the aluminum foils are softened due to the drying step or the like after an active material is applied, the rupture and the like of the aluminum foil are prevented, and the charge and discharge characteristics are improved using the foils in a soft state.

Patent Literature 1 describes the enhancement of the tensile elongation percentage of a cathode by adopting means for heat-treating an aluminum foil at a predetermined temperature for predetermined time.

Patent Literature 2 provides an aluminum foil which begins softening from around 120° C. without softening at a temperature of around 100° C., and is recrystallized at as low a temperature of 200° C. or less as possible, resulting in increase in elongation.

Patent Literature 3 describes the enhancement of the flexibility of a collector by heat-treating the cathode plate after pressing, and performing the grain growth of the crystal grains of the collector.

Additionally, Patent Literature 4 describes the softening of a current collecting foil by heating a roll to be contacted with the current collecting foil at a temperature of 200° C. or more and 400° C. or less.

### CITATION LIST

### Patent literature

[Patent literature 1]
Japanese Patent No. 4560079

[Patent literature 2]
Japanese Patent No. 5591583

[Patent literature 3]
Japanese Patent Laid-Open No. 2011-76969

[Patent literature 4]
Japanese Patent Laid-Open No. 2016-103338

### SUMMARY OF THE INVENTION

### Technical Problem

Incidentally, when an aluminum alloy foil is not sufficiently softened, the heat treatment temperature needs to be set as a high temperature at the time of the heat treatment of the aluminum alloy foil. However, the adhesion of foils called blocking occurs, or a resin deteriorates when the foil is coated with the resin before softening in the case. Further, problems such as the prolongation of heat treatment cycles resulting in decrease in productivity and increase in energy consumption at the time of heat treatment occur. When the foil is hardly softened due to heat treatment at low temperature and ununiformly softened, there is a possibility that unintended foils in a hard state are mixed depending on the production lot.

The present invention has been completed in light of the above-mentioned situation. An object thereof is to provide an aluminum alloy hard thin foil for a secondary battery cathode collector, wherein the aluminum alloy hard thin foil is sufficiently and uniformly softened at comparatively low temperature, a secondary battery cathode collector, and a method for manufacturing the aluminum alloy hard thin foil.

### Solution to Problem

According to a first aspect of an aluminum alloy hard thin foil for a secondary battery cathode collector according to the present invention, the aluminum alloy hard thin foil has an alloy composition wherein a content of Fe is 0.05 to 2.0% by mass, with the balance being aluminum and inevitable impurities; a recrystallization completion temperature is 250° C. or less; and a foil thickness is 5 to 50 μm.

An aluminum alloy hard thin foil for a secondary battery cathode collector according to another aspect comprises an aluminum alloy having a composition wherein a total content of Cu, Mg, Cr and Zr among the inevitable impurities is 0.05% by mass or less in the present invention of the aspect.

An aluminum alloy hard thin foil for a secondary battery cathode collector according to another aspect comprises an aluminum alloy having a composition wherein further a content of Mn among the inevitable impurities is 0.05% by mass or less in the present invention of the aspect.

The invention of an aluminum alloy hard thin foil for a secondary battery cathode collector according to another aspect has a recrystallized grain size of 5 to 100 μm.

A secondary battery cathode collector of the present invention has the aluminum alloy hard thin foil in the aspect.

A method for manufacturing an aluminum alloy hard thin foil for a secondary battery cathode collector according to the present invention comprises: subjecting an aluminum alloy having the composition according to the aspect to intermediate annealing once or more during cold rolling; and subjecting the resulting alloy to cold rolling wherein a reduction ratio from after final intermediate annealing to after final cold rolling is 85% or more.

Reasons for limiting components, manufacturing conditions and the like prescribed in the present invention will be described hereinafter. All the contents of components are shown by % by mass.

### Fe: 0.05 to 2.0%

Fe is crystallized as intermetallic compounds with Si and Mn at the time of casting, and has the effect of reducing the amounts of elements dissolved. When the amount thereof is less than 0.05%, the obtained effect is little. When the amount thereof is more than 2.0%, coarse intermetallic compounds are produced at the time of casting, resulting in decrease in the elongation and rollability of the foil. For this reason, the content of Fe is fixed at 0.05 to 2.0%. It is desirable that the lower limit be 0.3%, and the upper limit be 1.7% for the same reason.

### Recrystallization Completion Temperature: 250° C. or Less

When the heating temperature is more than 250° C., the possibility of blocking increases, and almost all the resin deteriorates for a short time. Therefore, the recrystallization completion temperature is fixed at 250° C. or less. Meanwhile, when the recrystallization completion temperature is less than 50° C., the aluminum alloy is recrystallized at room temperature and softened before foil processing. For this reason, it is desirable that the recrystallization completion temperature be 50 to 250° C. Additionally, it is still more desirable that the lower limit be 100° C., and the upper limit be 200° C. for the same reason. The recrystallization completion temperature refers to a temperature at which 0.2% proof stress changes into 0.2% proof stress after heat treatment at 350° C. (softening saturation) +5 MPa or less.

### Foil Thickness: 5 to 50 μm

When the foil thickness is less than 5 μm, the foil is insufficient in load capacity at the time of use, and is difficult to handle at the time of foil processing and also difficult to manufacture. When the foil thickness is more than 50 μm, a merit of thin foil is hardly obtained. To secure battery capacity when the foil is used for a secondary battery cathode collector, it is desirable that the foil thickness be 50 μm or less. For this reason, the foil thickness is fixed at 5 to 50 μm. It is desirable that the lower limit be 6 μm, and the upper limit be 30 μm, and it is still more desirable that the lower limit be 10 μm, and the upper limit be 20 μm for the same reason.

### Cu/Mg/Cr/Zr: The Total Content is 0.05% or Less

Cu, Mg, Cr and Zr have the effect of delaying the start of recrystallization in even a very small amount. When they are contained in a total amount of more than 0.05%, the delay in recrystallization due to solid solubility occurs, resulting in a rise in recrystallization completion temperature. For this reason, the total content of Cu, Mg, Cr and Zr is fixed at 0.05% or less. It is desirable that the upper limit be 0.03% or less, and it is still more desirable that the upper limit be 0.01% or less for the same reason. Some or all of these components are not optionally contained.

### Mn: 0.05% or Less

Mn has the effect of delaying the start of recrystallization even alone in a very small amount. When the amount thereof is more than 0.05%, the recrystallization completion temperature rises. For this reason, the content of Mn is fixed at 0.05% or less. It is desirable that the content of Mn be 0.02% or less for the same reason.

The aluminum alloy hard thin foil of the present invention can be obtained as a foil having a thickness of 5 to 50 μm through hot rolling, cold rolling, intermediate annealing during cold rolling and the final cold rolling, which is the last one passage of cold rolling. Prescriptions in manufacturing steps will be described hereinafter.

Reduction Ratio from After Final Intermediate Annealing to After Final Cold Rolling: 85% or More

When the reduction ratio is low after the final intermediate annealing, recrystallized grains become coarse, resulting in low elongation at the time of softening by heat treatment, and the aluminum alloy is difficult to handle in a soft state. For this reason, it is desirable that the lower limit of the reduction ratio be 85%. Although the upper limit of the reduction ratio is not prescribed, the effect of suppressing the coarsening of the recrystallized grains is saturated at even a high reduction ratio, and there is a possibility that work hardening becomes so high that the foil rollability deteriorates. It is desirable that the reduction ratio from after the final intermediate annealing to after the final cold rolling be 90 to 99.9% for the same reason. The reduction ratio refers to the rate of decrease in plate thickness, and is expressed by the percentage of (T0-T1)/T0, wherein T0 is an initial plate thickness, and T1 is a plate thickness after rolling.

### Intermediate Annealing

When intermediate annealing is not performed during rolling, recrystallized grains become coarse, resulting in low elongation at the time of softening by heat treatment, and the aluminum alloy is difficult to handle in a soft state. For this reason, although intermediate annealing is optionally performed a plurality of times, it is performed once or more. At this time, it is desirable to fix the temperature of intermediate annealing at 270° C. or more. When the temperature of intermediate annealing is low, there is a possibility that partial recrystallization occurs at the time of intermediate annealing, there is a possibility that some of recrystallized grains after the foil is heat-treated are coarsened, resulting in decrease in elongation in a soft state, and the foil is ruptured locally. It is desirable that the temperature be 300° C. or more for the same reason. It is desirable to perform annealing by batch annealing.

### Recrystallized Grain Size: 5 to 100 μm

When the recrystallized grain size is more than 100 μm after heat treatment, the elongation is low with the foil in a soft state, and the foil is difficult to handle. Although the lower limit is not prescribed, it is desirable that it be 5 μm or more. For this reason, the recrystallized grain size is fixed at 5 to 100 μm. It is desirable that the lower limit of the recrystallized grain size be 5 μm, and the upper limit be 60 μm, and it is still more desirable that the lower limit be 5 μm, and the upper limit be 50 μm for the same reason. The recrystallized grain size refers to an average crystal grain size at a recrystallization completion temperature.

### Advantageous Effects of Invention

According to the present invention, when an aluminum alloy hard thin foil is heat-treated, it can be softened at comparatively low temperature, the adhesion of foils called blocking can be prevented, and collectors for secondary batteries excellent in performance can be manufactured efficiently.

### Description of Embodiments

One embodiment of the present invention will be described hereinafter. An aluminum alloy having a composition of the present invention is subjected to melting and casting by semi-continuous casting. The obtained ingot is subjected to homogenization treatment, and facing or the like is then performed, resulting in the cleaning of the surface. Then, the ingot is sequentially subjected to hot rolling, cold rolling, intermediate annealing during cold rolling and the final cold rolling as finish, resulting in the gradual reduction of the thickness from a plate shape through a sheet shape to a foil shape, and an aluminum alloy foil can be manufactured.

Intermediate annealing during cold rolling is desirably performed at 270° C. or more. An aluminum alloy hard thin foil having a thickness of 5 to 50 μm can be obtained through the subsequent final cold rolling. At this time, it is desirable that the reduction ratio from after the final intermediate annealing to after the final cold rolling be 85% or more.

When the 0.2% proof stress of the aluminum alloy hard thin foil after the final cold rolling is less than 100 MPa, the foil does not have “tear resistance”, the handle in the subsequent steps is difficult, and a merit of hard foil is not obtained. For this reason, it is desirable that the 0.2% proof stress after the final cold rolling be 100 MPa or more, and it is still more desirable that it be 150 MPa or more.

An embodiment when an aluminum alloy hard thin foil of the present invention is used for a cathode collector of a lithium ion secondary battery will be described hereinafter.

Cathode active material slurry is applied to the obtained aluminum alloy hard thin foil. The cathode active material slurry is a mixture consisting of a cathode active material, an electro-conductive material, a binder, a diluent and the like. Examples of the components include the following. LiCoO₂, LiMnO₂, LiFePO₄ or the like is used for the cathode active material. Acetylene black or the like is used for the electro-conductive material. Polyvinylidene fluoride (PVDF) or the like is used as the binder, and an N-methyl-2-pyrrolidone (NMP) or the like is used as the diluent. The aluminum alloy hard thin foil coated with the cathode active material slurry is heat-treated, and a lithium ion secondary battery cathode plate can be obtained.

Although it is desirable to perform heat treatment at 100 to 250° C., there is a possibility that the cathode active material or the binder deteriorates at high temperature. Therefore, it is more desirable to perform it in the temperature range of 160 to 220° C.

It is desirable that the obtained aluminum alloy hard thin foil have a recrystallized grain size of 5 to 100 μm by heat treatment under the conditions.

Although the aluminum alloy hard thin foil can be used for various uses, it can be suitably used for cathode plates of lithium ion secondary batteries as an aluminum alloy hard thin foil for lithium ion secondary battery cathode collectors. The lithium ion secondary batteries excellent in performance can be obtained using the above-mentioned cathode plate.

### EXAMPLES

### Example 1

An aluminum alloy ingot having a composition shown in table 1 (with the balance being Al and other inevitable impurities) and a thickness of 500 mm was produced. The surface of the ingot was subjected to facing, and the ingot was subjected to homogenization treatment of 500° C.×5 hours, then cooled, reheated to 520° C., reduced to 5.0 mm in thickness by hot rolling, and cold rolling, intermediate annealing, re-cold-rolling and the final cold rolling, which is the last one passage of cold rolling was performed to obtain a foil of 20 μm in thickness and 1000 mm in width. Superposition is optionally performed at the time of the final cold rolling.

The foil was rolled to 0.7 mm in thickness, and the intermediate annealing was then performed. Treatment of 350° C.×3 hours was performed in a batch annealing furnace.

The aluminum alloy hard thin foil after the final cold rolling was subjected to a tensile test by a JIS No. 5 specimen, and the 0.2% proof stress was measured. The result is shown in table 1.

The aluminum alloy hard thin foil after the final cold rolling was heated at 350° C. and various temperatures for 3 hours (heating-rate: 50° C./hr, in an atmospheric furnace). The 0.2% proof stress was determined from the tensile test by each JIS No. 5 specimen. The heating temperature at which it was 0.2% proof stress after heat treatment at 350° C.+5 MPa or less was defined as the recrystallization completion temperature. The result is shown in table 1.

The recrystallized grain size was measured in the rolled surface of the foil heat-treated at the recrystallization completion temperature. The sample aluminum alloy hard thin foil was subjected to electrolytic polishing with a mixed solution of 20% perchloric acid+80% ethanol. Then, crystal grain structure was revealed by Barker's solution method, and the crystalline structure was observed through a polarization microscope. The average crystal grain size was determined from structural photographs by the intercept-line method. Three fields of view were observed per sample, and the average of the three fields of view was determined as the average crystal grain size. In the samples of Examples 1 to 7 according to the present invention, all the recrystallized grain sizes were 60 μm or less.

### COMPARATIVE EXAMPLE

Since all of Comparative Examples 1 to 3 cannot satisfy the recrystallization completion temperature, and heat treatment at high temperature is necessary, there is a possibility that blocking occurs, the resins deteriorate, the active materials are inactivated, and the like. In the same alloy components as Example 3, both a foil produced without IA (intermediate annealing) and a foil produced by performing IA twice, setting the reduction ratio after the final IA as 50% and the thickness as 50 μm had a recrystallized grain size of more than 100 μm, resulting in decrease in the elongation in a soft state. Additionally, in a foil subjected to intermediate annealing at 260° C., some of the recrystallized grains were coarsened to around 200 μm, resulting in decrease in elongation in a soft state.

TABLE 1

| | | | | | | Recrystal- |
|---|---|---|---|---|---|---|
| | | | | | | lization |
| | | Alloy component (wt %) | | | YS (MPa) | completion |
| | | | | Cu + Mg + | after final | temperature |
| | | Fe | Mn | Cr + Zr | cold rolling | (° C.) |
| Example | 1 | 0.08 | 0.00 | 0.00 | 141 | 250 |
| | 2 | 0.48 | 0.00 | 0.04 | 163 | 240 |
| | 3 | 0.59 | 0.00 | 0.00 | 156 | 200 |
| | 4 | 0.87 | 0.00 | 0.02 | 164 | 220 |
| | 5 | 1.43 | 0.00 | 0.00 | 159 | 160 |
| | 6 | 1.53 | 0.01 | 0.01 | 172 | 220 |
| | 7 | 1.03 | 0.03 | 0.00 | 166 | 240 |
| Comparative | 1 | 0.72 | 0.01 | 0.15 | 213 | 280 |
| Example | 2 | 0.44 | 1.07 | 0.16 | 237 | 300 |
| | 3 | 1.16 | 0.19 | 0.04 | 207 | 280 |

Although the present invention was described based on the above-mentioned embodiments and Examples, the present invention is not limited to the contents of the above-mentioned description. Unless it deviates from the scope of the present invention, the above-mentioned embodiments and Examples can be properly modified.

1. An aluminum alloy hard thin foil for a secondary battery cathode collector, wherein the aluminum alloy hard thin foil has an alloy composition wherein a content of Fe is 0.05 to 2.0% by mass, with the balance being aluminum and inevitable impurities; a recrystallization completion temperature is 250° C. or less; and a foil thickness is 5 to 50 μm.

2. The aluminum alloy hard thin foil for a secondary battery cathode collector according to claim 1, comprising an aluminum alloy having a composition wherein a total content of Cu, Mg, Cr and Zr among the inevitable impurities is 0.05% by mass or less.

3. The aluminum alloy hard thin foil for a secondary battery cathode collector according to claim 1, comprising an aluminum alloy having a composition wherein further a content of Mn among the inevitable impurities is 0.05% by mass or less.

4. The aluminum alloy hard thin foil according to claim 1, wherein the aluminum alloy hard thin foil has a recrystallized grain size of 5 to 100 μm.

5. A secondary battery cathode collector comprising the aluminum alloy hard thin foil according to claim 1.

6. A method for manufacturing an aluminum alloy hard thin foil for a secondary battery cathode collector, the method comprising:
subjecting an aluminum alloy having the composition according to claim 1 to intermediate annealing once or more during cold rolling; and
subjecting the resulting alloy to cold rolling wherein a reduction ratio from after final intermediate annealing to after final cold rolling is 85% or more.

7. The aluminum alloy hard thin foil for a secondary battery cathode collector according to claim 2, comprising an aluminum alloy having a composition wherein further a content of Mn among the inevitable impurities is 0.05% by mass or less.

8. The aluminum alloy hard thin foil according to claim 2, wherein the aluminum alloy hard thin foil has a recrystallized grain size of 5 to 100 μm.

9. The aluminum alloy hard thin foil according to claim 3, wherein the aluminum alloy hard thin foil has a recrystallized grain size of 5 to 100 μm.

10. A secondary battery cathode collector comprising the aluminum alloy hard thin foil according to claim 2.

11. A secondary battery cathode collector comprising the aluminum alloy hard thin foil according to claim 3.

12. A secondary battery cathode collector comprising the aluminum alloy hard thin foil according to claim 4.

13. A method for manufacturing an aluminum alloy hard thin foil for a secondary battery cathode collector, the method comprising:
subjecting an aluminum alloy having the composition according to claim 2 to intermediate annealing once or more during cold rolling; and
subjecting the resulting alloy to cold rolling wherein a reduction ratio from after final intermediate annealing to after final cold rolling is 85% or more.

14. A method for manufacturing an aluminum alloy hard thin foil for a secondary battery cathode collector, the method comprising:
subjecting an aluminum alloy having the composition according to claim 3 to intermediate annealing once or more during cold rolling; and
subjecting the resulting alloy to cold rolling wherein a reduction ratio from after final intermediate annealing to after final cold rolling is 85% or more.
